(19) United States
(12) Patent Application Publication
(10) Pub. No.: US 2025/0006175 A1
(43) Pub. Date: Jan. 2, 2025

(54) Adaptation and training of neural speech synthesis

(71) Applicant: Cerence Operating Company, Burlington, MA (US)

(72) Inventors: Paolo Coppo, Turin (IT); Matteo Testa, Turin (IT); Vincent Pollet, Burlington, MA (US)

(21) Appl. No.: 18/710,301

(22) PCT Filed: Dec. 7, 2022
(86) PCT No.: PCT/US2022/052095

§ 371 Date: May 15, 2024

Related U.S. Application Data
(60) Provisional application No. 63/288,907, filed on Dec. 13, 2021.

(51) Int. Cl. G10L 13/047; G10L 13/033; G10L 13/10; G10L 21/0208; G10L 25/18; G10L 25/60

(52) U.S. Cl. CPC G10L 13/047; G10L 13/033; G10L 13/10; G10L 21/0208; G10L 25/18; G10L 25/60

(57) ABSTRACT

Disclosed are systems, methods and other implementations for speech generation, including a method that includes obtaining a speech sample for a target speaker, processing, using a trained encoder, the speech sample to produce a parametric representation of the speech sample for the target speaker, receiving configuration data for a speech synthesis system that accepts as an input the parametric representation, and adapting the configuration data for the speech synthesis system according to an input comprising the parametric representation, and a time-domain representation for the speech sample, to generate adapted configuration data for the speech synthesis system. The method further includes causing configuration of the speech synthesis system according to the adapted configuration data, with the speech synthesis system being implemented to generate synthesized speech output data with estimated voice and time-domain speech characteristics approximating actual voice and time-domain speech characteristics for the target speaker.

### CROSS REFERENCE TO RELATED APPLICATIONS

This application is an international application, which claims priority to U.S. Provisional Application No. 63/288,907, filed Dec. 13, 2021, the contents of which are herein incorporated by reference.

### BACKGROUND OF THE INVENTION

The present disclosure relates to voice cloning, and more particularly to voice cloning for a target speaker who provides a short (e.g., 10 minutes, but other sample lengths, shorter (e.g., 2-3 minutes) or longer than 10 minutes, may be used instead) speech sample, based on which a natural-sounding voice that incorporate the speaker's unique speech characteristics (accent, style, prosody, etc.) is synthesized.

Speech synthesis systems process textual input to generate output speech that is intended to emulate human speech (such systems are also referred to as text-to-speech (TTS) systems). Various techniques to generate the speech output based, for example, on phonetic information and prosody information include sample-based techniques and parameter-based techniques. A sample-based technique may use a database of pre-recorded speech samples. The phonetic information and the prosody information may be used as a basis for both selecting a set of the pre-recorded speech samples and concatenating the selected set together to form the output speech. The overall performance of the sample-based techniques may be dependent on the size of the database of pre-recorded speech samples and/or the manner in which the pre-recorded speech samples are organized within the database and selected. Because the pre-recorded speech samples depend on segmentation techniques to determine the pre-recorded samples, there may be audible glitches in the synthesized speech.

A parameter-based technique does not use pre-recorded speech samples at runtime. Instead, the output speech may be generated based on an acoustic model that parameterizes human speech. Parameter-based techniques can produce intelligible synthesized speech, but the generated speech is sometimes less-natural sounding (e.g., compared, for example, to a sample-based technique).

### SUMMARY

The present disclosure is directed to a solution to produce natural sounding synthesized speech for a target speaker based on a relatively short sample (e.g., 10 minutes or less) acquired for the target speaker. The system utilizes a trainable multi-speaker parametrized model (e.g., implemented using a learning-machine system, such as a neural network-based speech synthesizing system). This multi-speaker model is trained using a large corpus of recorded speech from multiple speakers, each of which is associated with an encoded vector (also referred to as an embedding). The encoded vectors define an embedding space representative of at least some voice characteristics for speakers in the large corpus (for example generally characterizing spectral domain characteristic). A target speaker, typically different than any of the speakers used to train the multi-speaker model employed for the TTS, provides a short sample of speech, based on which a trained encoder generates an embedding vector that is representative of the target speaker's voice characteristics (e.g., as a centroid or average of a set of utterance-level embeddings for the target speaker). The encoded embedding for the target speaker lies within the embedding space defined for the trained encoder, and can be used to condition (effectively to control or modulate, as will be described in greater detail below) the voice characteristics produced by the speech synthesis system, to synthesize speech that closely emulates/approximates the voice characteristics of the target speaker.

To further enhance the naturalness of the synthesized speech to more closely approximate the synthesized speech to the way the target speaker would utter arbitrary utterances, the multi-speaker model implementation also uses information representative of time-domain speech characteristics of speech uttered by the target speaker (e.g., speech pronunciation by the target speaker, accent of the target speaker, speech style for the target speaker, and/or prosody characteristics for the target speaker). To achieve this naturalness of cloned voice to match the speaker's more stylistics characteristics, a non-parametric adaptation process (i.e., a process that goes beyond conditioning of the target speakers embedding) is applied to the speech synthesis system to adjust the model (e.g., based on the short speech sample provided and recorded for the target speaker) to represent the stylistic characteristics of the target speaker's speech. For example, the speech synthesis system can undergo an optimization adjustment process to adjust (e.g., adapt, modify) the trained configuration (e.g., weights of a neural network-based implementation of one or more of the components/sub-system of the synthesizing system) based on the short speech sample provided for the target speaker and annotation information matched to the speech sample, to provide a more optimal performance with respect to the specific target speaker whose speech is to be cloned.

In some embodiments, further improvements in the performance of the speech synthesis system, to produce a more natural sounding cloned speech for a target speaker, are achieved by an adaptation monitoring process that determines, using computed dispersion metric, the stability of a voice cloning process (e.g., by determining the stability of an optimization process used in the course of the non-parametric adaptation process). As will be described in greater detail below, a stability metric (e.g., as an entropy metric) is computed (e.g., during the non-parametric adaptation process) to evaluate the stability of the emerging optimization solution. If, in some embodiments, the stability metric is determined to be converging to a non-stable solution (as indicated by dispersive behavior of the computed entropy metric), the current adaptation process is aborted, and either a new speech sample is acquired (potentially using different utterances/words prompted from the target speaker), or the adaptation process is re-started.

The approaches and solutions described herein can be used in conjunction with different speech synthesis architectures or frameworks. For example, the presently described neural speech synthesis models for multi-speaker training, and adaptation techniques to create personalized voices and synthesize naturally-sounding speech may be applied to Tacotron model architectures (including Tacotron 2 model architecture), noise diffusion model class, Diffwave model class, generated adversarial network (GAN)-based wave synthesis, etc. The present approaches and solutions can also be used in conjunction with audio watermarking techniques configured to determine the origin of an audio fragment (e.g., whether the audio portion is authentic or was produced by a voice clone). The approaches and solutions described herein perform non-parametric adaptation that in combination with style embeddings jointly models the speaker which is the target for voice cloning. The approaches and solutions described herein achieve improved voice cloning that better imitates the prosody of the target speaker.

The techniques and approaches described herein include implementations to find and refine acquired speech samples to create individual synthetic voice using unsupervised signal enhancement, annotation, transcription, and/or selective rejection of training processes. The techniques and approaches of the present disclosure can be performed with speech samples (from target speakers whose voice and speech characteristics are sought to be cloned) of 10 minutes, or shorter (e.g., 3 minutes), or longer (e.g., 2 hours).

Thus, in some variations a method for speech generation is provided that includes obtaining a speech sample for a target speaker, processing, using a trained encoder, the speech sample for the target speaker to produce a parametric representation of the speech sample for the target speaker, receiving configuration data for a speech synthesis system that accepts as an input the parametric representation, and adapting the configuration data for the speech synthesis system according to an input comprising the parametric representation for the target speaker, and a time-domain representation for the speech sample for the target speaker, to generate adapted configuration data for the speech synthesis representing the target speaker. The method also includes causing configuration of the speech synthesis system according to the adapted configuration data (which may include the parametric representation of the target speaker), with the speech synthesis system comprising the adapted configuration data being implemented to generate synthesized speech output data with estimated voice and time-domain speech characteristics approximating actual voice and time-domain speech characteristics for the target speaker.

Embodiments of the method may include at least some of the features described in the present disclosure, including one or more of the following features.

The configuration data may include weights for a neural-network-based implementation of the speech synthesis system.

Adapting the configuration data according to the time-domain representation may include matching the speech sample and corresponding linguistic annotation for the speech sample to generate an annotated speech sample identifying phonetic and silent portions, and respective time information, with the annotated speech sample representing the time-domain speech attributes data for the target speaker, and adapting the configuration data for the speech synthesis system according to, at least in part, the annotated speech sample representing the time-domain speech attributes data for the target speaker.

The time-domain speech attributes data for the target speaker may include one or more of, for example, speech pronunciation by the target speaker, accent of the target speaker, speech style for the target speaker, and/or prosody characteristics for the target speaker.

The linguistic annotation may include word and/or sub-word transcriptions, and matching the speech sample the corresponding linguistic annotation may include aligning word and/or subword elements of the transcriptions with the time-domain representation of the target speech sample for the target speaker.

The method may further include generating the synthesized speech output data, including processing a target linguistic input by applying the speech synthesis system configured with the adapted configuration data to the target linguistic input to synthesize speech with the voice and time-domain speech characteristics approximating the actual voice and time-domain speech characteristics for the target speaker uttering the target linguistic input.

Obtaining the speech sample for the target speaker may include obtaining a speech corresponding to a linguistic representation of spoken content of the speech sample.

Obtaining the speech sample for the target speaker may include conducting a scripted data collection session with the target speaker, including prompting the target speaker to utter the spoken content.

The method may further include performing audio validation analysis for the speech sample to determine whether the speech sample satisfies one or more audio quality criteria, and obtaining a new speech sample in response to a determination that the speech sample fails to satisfy the one or more audio quality criteria.

The method may further include applying filtering and speech enhancement operations on the speech sample to enhance quality of the speech sample.

The received configuration data for the speech synthesis system may be derived from training speech samples from multiple training speakers distinct from the target speaker.

Adapting the configuration data may include computing an adaptation stability metric representative of adaptation performance for adapting the configuration data, and aborting the adapting of the configuration data in response to a determination that the computed adaptation stability metric indicates unstable adaptation of the configuration data.

The method may further include re-starting the adapting of the configuration data using the speech sample for the target speaker.

The method may further include obtaining, following the aborting, a new speech sample for the target speaker, and performing the adapting of the configuration data using the new speech sample.

Computing the adaptation stability metric may include computing attention data for portions of the speech sample. Aborting the adapting of the learning-machine-based synthesizer may include aborting the adapting of the learning-machine-based synthesizer in response to a determination that attention dispersion level derived from the attention data indicates a non-converging adapting solution for the speech synthesis system.

Processing, using the trained encoder, the speech sample for the target speaker to produce the parametric representation may include transforming the speech sample for the target speaker into a spectral-domain vector representation.

Transforming the speech sample into the spectral-domain vector representation may include transforming the speech sample into a plurality of mel spectrogram frames, and mapping the plurality of mel spectrogram frame into a fixed-dimensional vector.

The method may further include generating, using a variational autoencoder, a parametric style representation for the prosodic style associated with the speech sample. Adapting the configuration data may include adapting the configuration data for the speech synthesis system based further on the parametric style representation.

Adapting the configuration data for the speech synthesis system according to the parametric representation for the target speaker and the time-domain representation for the speech sample may include adapting the configuration data using a non-parametric adaptation procedure to minimize error between predicted spectral representation data produced by the speech synthesis system in response to the parametric representation and text-data matching the speech sample for the target speaker, and actual spectral data directly derived from the speech sample.

In some variations, a speech generation system is provided that includes a speech acquisition section to obtain a speech sample for a target speaker, an encoder, applied to the speech sample for the target speaker, to produce a parametric representation of the speech sample for the target speaker, and a speech synthesis and cloning system. The speech synthesis and cloning system includes a receiver to receive configuration data for the speech synthesis system, with the speech synthesis system being configured to accept as an input the parametric representation, and an adaptation module to adapt the configuration data for the speech synthesis system according to an input comprising the parametric representation for the target speaker, and a time-domain representation for the speech sample for the target speaker, to generate adapted configuration data for the speech synthesis system representing the target speaker. The adaptation module causes configuration of the speech synthesis system according to the adapted configuration data, with the speech synthesis system including the adapted configuration data being implemented to generate synthesized speech output data with estimated voice and time-domain speech characteristics approximating actual voice and time-domain speech characteristics for the target speaker.

In some variations, a non-transitory computer readable media is provided that stores a set of instructions, executable on at least one programmable device, to obtain a speech sample for a target speaker, process, using a trained encoder, the speech sample for the target speaker to produce a parametric representation of the speech sample for the target speaker, receive configuration data for a speech synthesis and cloning system that accepts as an input the parametric representation, and adapt the configuration data for the speech synthesis and cloning system according to an input comprising the parametric representation for the target speaker, and a time-domain representation for the speech sample for the target speaker, to generate adapted configuration data for the speech synthesis and cloning system representing the target speaker. The set of instructions, when executed on the at least one programmable device, cause configuration of the speech synthesis and cloning system according to the adapted configuration data, with the speech synthesis and cloning system comprising the adapted configuration data being implemented to generate synthesized speech output data with estimated voice and time-domain speech characteristics approximating actual voice and time-domain speech characteristics for the target speaker.

In some variations, a computing apparatus is provided that includes a speech acquisition section to obtain a speech sample for a target speaker, and one or more programmable processor-based devices to generate synthesized speech according to any of the method steps described above.

In some variations, another non-transitory computer readable media programmed is provided, with a set of computer instructions executable on a processor that, when executed, cause the operations comprising any of the various method steps described above.

Embodiments of the above system, the apparatus, and/or the computer-readable media may include at least some of the features described in the present disclosure, and may be combined with any other embodiment, variation, or features of the method described herein.

Some embodiments may include cross language training to generate speech synthesis in a language that is different from the language for which the speech samples were collected for. Some embodiments may use audio samples obtained from data repositories on accessible networks (such as the Internet) or other sources, with those obtained audio samples then annotated.

Other features and advantages of the invention are apparent from the following description, and from the claims.

### BRIEF DESCRIPTION OF THE DRAWINGS

These and other aspects will now be described in detail with reference to the following drawings.

FIG. 1 is a schematic diagram of an example speech cloning system.

FIG. 2 is a schematic diagram of an example speech synthesizing section of a speech cloning system.

FIG. 3 is a flowchart of an example procedure for speech generation.

Like reference symbols in the various drawings indicate like elements.

### DETAILED DESCRIPTION

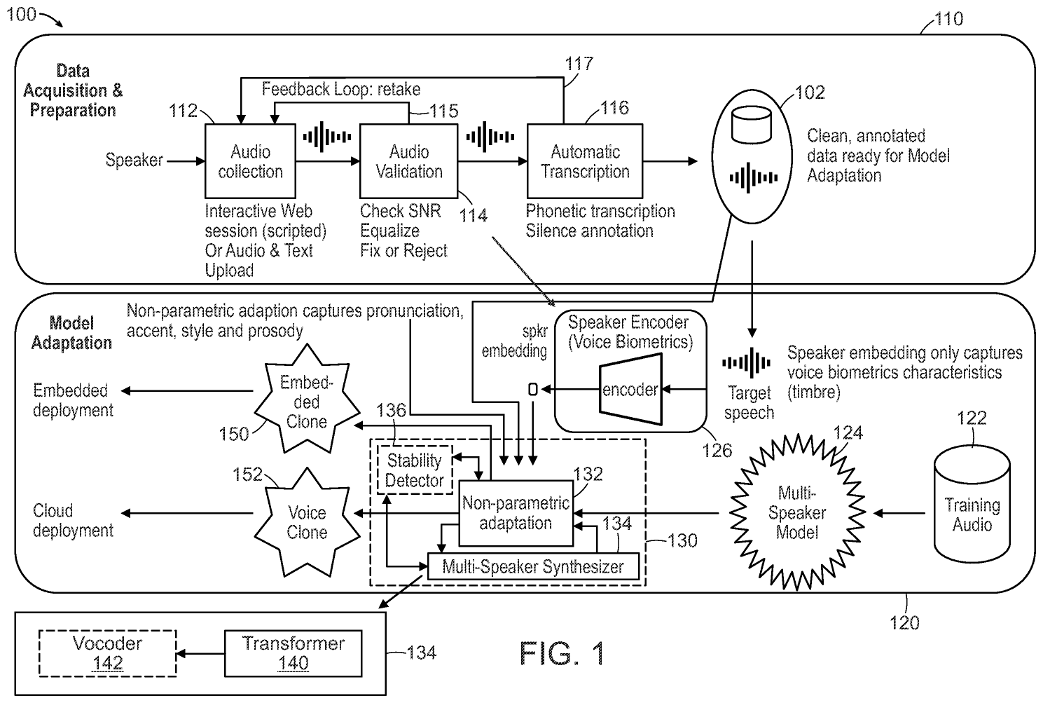

FIG. 1 is a diagram of a speech cloning system 100. The system 100 is depicted with two separate principal sections, namely, a speech acquisition section 110 and a speech synthesizing and cloning section 120. Generally, the speech synthesizing and cloning section 120 is housed at a central location (and implemented as single or several distributed computing servers or devices), while the speech acquisition section 110 (or at least parts of it) is located remotely from the speech synthesizing and cloning section 120, with the two sections communicating through wired and/wireless channels. Alternatively, the two sections may reside on the same device. Furthermore, while only one speech acquisition section 110 is illustrated, the speech synthesizing section 120 may be in communication and perform speech synthesizing operations based on data provided from multiple independent devices. It should be noted that the speech synthesizing and cloning section 120 is configured to perform “cloning time” (generally offline) cloning operations (e.g., to configure and adapt a previously configured synthesis model that was previously configured at a “multi-speaker training time” to form the cloning model for a particular target speaker), with the resultant cloned model then transferred to a downstream speech synthesis system (e.g., on a personal device, in a car, in a cloud server, etc.) for later “run time” speech synthesis in the target speaker's voice (not shown in FIG. 1). However, in some embodiments, and as will be discussed in greater detail below, the section 120 may also be configured to perform runtime speech synthesis as well.

An example of a device on which the speech acquisition section 110 may be implemented is a wireless device such as a smartphone, or a personal computing device (such as a laptop computing device) that can establish communication links with the platform implementing the speech synthesis according to multiple different communication technologies or protocols (e.g., WLAN-based communication technologies such as WiFi protocols, WWAN technologies, such as LTE-based communication protocols, 5G protocols, etc.). As shown in FIG. 1, the speech acquisition section 110 includes an audio collection unit 112, which generally includes one or more voice transducers (microphones), and recording medium (typically a memory storage device to store digitized samples of the recorded audio sample). The audio collection unit 112 also includes a user input/output interface through which a user may be prompted to utter a pre-determined speech sample. For example, in embodiments in which the audio collection unit 112 is implemented using a device that includes a display, a pre-determined text passage is presented to the user via the display, which the target speaker can then repeat aloud to have the smartphone or computing device to convert to the speech sample to digital form (using an analog-to-digital converter, and any other needed filtering) and store it in the storage medium of the recording device.

The recorded speech sample may, in some embodiments, be analyzed by an audio validation unit 114 (illustrated in FIG. 1) that may be configured to process the recorded speech to perform filtering operations to refine the quality of the recorded speech sample from the target user and/or to determine if the quality of the recorded signal satisfies quality criteria. For example, the audio validation unit 114 may compute the signal-to-noise ratio (SNR), or compute some other audio quality metric, for the recorded speech sample. The audio validation unit 114 may then determine whether the computed audio quality metric satisfies (e.g., exceeds) a reference value (threshold value) used to assess the audio quality criteria. If it is determined, as a result of the analysis/evaluation performed by the audio validation unit 114 that the speech sample obtained fails to satisfy the one or more audio quality criteria (e.g., is the SNR computed for the speech sample is below some pre-determined reference SNR value), the audio validation unit 114 may cause the audio collection unit 112 (e.g., by sending a request message via a link 115) to request the target speaker (via the user interface of the audio collection unit 112) to record a new speech sample (based on the same linguistic content used to record the current speech sample, or based on new content). In some embodiments, the audio validation unit 114 may also be configured to perform various filtering processes/operation to enhance the audio quality of the acquired current speech sample. For example, the audio validation unit may include an equalizer, realized using fixed or adaptable filtering implementations (e.g., based on finite impulse response (FIR) or infinite filter response (IIR) filters, or through other filtering representations). Such an equalizer may be used to remove noise, or to otherwise adjust the input signal provided to the equalizer in some desired manner. Other types of enhancing processing/filtering performed on the speech sample to enhance the collected sample's quality (to make it more suitable for training) include different types of denoising processing techniques, different types of dereverberation processing, etc.

Once a speech sample that meets one or more of the audio quality criteria has been acquired, the audio validation unit 114 forwards the resultant speech sample to an automatic transcription unit 116 that is configured to generate a time-domain representation, including an alignment of speech samples with transcription units (e.g., words or subword elements, phonemes, etc.), that is used to adapt a speech synthesis system (such as the speech synthesis system 130 depicted in FIG. 1). It is to be noted that in some examples only the speech acquisition unit 112, and possibly some of the circuitry of audio validation unit would reside on a device or browser (of a personal computer with which the target speaker is interacting), while the automatic transcription unit 116 runs in a central server (e.g., a cloud-based server). The adaptation of the speech synthesis system is such that synthesized speech would have voice characteristics (e.g., spectral characteristics, such as timbre) and time-domain speech characteristics (speaking style, accent, prosody, etc.) approximating the actual time-domain speech characteristics and actual voice characteristics of the target speaker providing the input speech sample via the audio collection unit 112.

In some implementations, the time-domain representation may include a linguistic annotation generated for the speech sample (processed by the audio validation unit 114) that matches the speech sample signal to the text-content that the target speaker was prompted to utter and record. Such matching of the time-domain audio content of the speech sample and the text content aligns words and/or subword elements of the transcription with the target speech sample. The aligning of words and sub-words provided in the text-content and the actual audio-content uttered by the speaker may be performed through machine-learning processes, in which a learning machine (implemented for the automatic transcription unit 116) is trained to associate, or align, written representations of words, subwords, phonemes, silence portions, etc., with corresponding audio content. The transcription processing may be performed through speech recognition and/or an alignment process to a known transcript. Alternatively or additionally, the automatic transcription unit 116 may perform natural language processing operation on the audio speech sample to independently recognize linguistic content of the audio speech sample, for example, if the input does not follow a known script for which any needed natural-language based annotation is already available. For example, target speech samples available through shared audio repositories (e.g., on YouTube) may be retrieved and used for cloning-based speech synthesizing operations. In such situations NLP operations may be applied to the retrieved speech samples (for which a corresponding annotated text-based linguistic content may not be available) to generate an annotation matching the audio content. Natural language processing is applied to a data source(s) (in this case, the speech sample outputted by the audio validation unit 114) to process human language for meaning (semantics) and structure (syntax). NLP can differentiate meaning of words/phrases and larger text units based on the surrounding semantic context. In some embodiments, syntactical processors assign or “parse” units of text to grammatical categories or “part-of-speech” (noun, verb, preposition, etc.) Semantic processors assign units of text to lexicon classes to standardize the representation of meaning. The automatic transcription unit 116 may thus employ an NLP engine that recognizes the words uttered by the speaker and determines the phonetic order of those utterances. As a result, such an NLP engine allows the automatic transcription unit 116 to identify boundaries (begin and end times) for words and subwords portions, or phonemes, in the audio speech sample, and match it to the text-content (i.e., the linguistic content) of the passage that the target speaker had recited when providing the speech sample. In the event of a mismatch between the audio content and the text-content, e.g., when a confidence level associated between matched parts is below some threshold level, or when certain percentage of the independently recognized words and subwords, or phonemes, do not match words, subwords, and/or or phonemes in the text-content (this may result from the speaker providing an audio sample that is at odds with what the audio collection unit may have prompted the speaker to provide), a determination may be made to discard the present speech sample, and acquire a new one. In such situations, the automatic transcription unit 116 may request the audio collection unit (using a message request sent via a link 117) to re-acquire a new source sample from the target speaker. It is to be noted that, in some embodiments, the actual speech sample may not match the expected phonetic transcription because the speaker pronounces one of the expected words in an unclear or unexpected way. In such situations, a process to adapt the phonetic transcription to the audio may need to be performed, or alternatively the audio speech sample may need to be discarded, and/or speaker asked to provide a new sample.

In situations where the speech sample can be substantially matched to the linguistic content used for recording the raw speech sample provided by the speaker, the automatic transcription unit 116 generates an annotated speech sample comprising the audio content of the speech sample, and information representing the phonetic transcription of speech sample. In some embodiments, the automatic transcription unit may alternatively generate an annotated speech sample comprising the audio content and the linguistic (semantic and syntactical) content of the speech sample. As will be described below in greater detail, this annotated speech sample is used perform two tasks. The first task to generate, by a separate encoder (e.g., a trained learning-machine-based encoder) a parametric input (e.g., in the form of a fixed-dimensioned vector) provided to a trained speech synthesis system so as to cause the speech synthesis system to produce an output based on which synthesized speech is generated with voice characteristics approximating that of the target speaker. The second task that uses the annotated speech sample is to adapt the speech synthesis system (through adjustment of configuration data, e.g., weights of a neural-network-based system that define the speech synthesis system implementation and functionality) to the speech characteristics of the speaker as represented by the annotated speech sample.

Thus, and with continued reference to FIG. 1, the speech synthesizing section 120 includes an encoder 126 coupled to a speech synthesis system 130 that may be implemented as a learning-machine, and may be configured to generate output that can be transformed into synthesize phonetic speech with voice and speech characteristics determined according to the adapted configuration data of the speech synthesis system 130. In some example embodiments, the encoder 126 (which may be realized as a learning-machine implementation) may be configured to compute a fixed-dimensional embedding vector from the reference speech of a target speaker (i.e., the speech sample 102). In such embodiments, the speech synthesizer system 130 may be configured to produce synthesized speech based on an embedding vector provided by the encoder 126, and based on input text. The speech synthesis/cloning system 130 may optionally include a voice encoder (a vocoder), which may also be implemented as a learning-machine system, and which is configured to infer/generate time-domain waveforms from the mel spectrograms generated by a token-to-spectrogram converter (also referred to as a “converter” or “encoder module”). The converter may, in some embodiments, convert input tokens into other types of output representations to be processed by a vocoder. The voice encoder may be implemented on the same or different device as other components of the speech synthesis system 130. As depicted in FIG. 1, in some examples the speech synthesis system (or at least parts of it) may be deployed (e.g., following the individual adaptation of the multi-speaker model for a particular target speakers) in individual devices (e.g., smartphones, laptops, speech interfaces included with various items such as a car, etc.) in an embedded deployment configuration (illustrated schematically as implementation 150), or may be deployed in a cloud deployment configuration (illustrated schematically as implementation 152) in a central location accessible by multi-users. In some embodiments, deployment of the speech synthesis system may follow the adaptation of the multi-speaker model to the specific target speaker (the adaptation of the multi-speaker model is also referred to as cloning time adaptation).

More particularly, during clone time (i.e., when the speech synthesis system is configured for a specific target speaker), the encoder 126 receives as input a short reference utterance (e.g., the speech sample 102) and generates, according to its internal learned speaker characteristics space, a parametric representation for the reference utterance (e.g., an embedding vector) representative of voice characteristics for target speaker (an embedding vector is generally generated for each input utterance, or alternatively based on multiple or all of the utterances for the speaker). The reference utterance is also provided to a non-parametric adaptation module 132 of the speech synthesis system 130 that is configured to adapt the configuration data produced for a multi-speaker synthesis model based on time-domain speech characteristics (e.g., style, accent, prosody, etc.) represented by the annotated speech sample 102. As noted, the annotated speech sample 102 includes timing information relating to the way words and subwords (or phonemes) are uttered, thus providing speech characteristics information on the way the target speaker pronounces or enunciates linguistic content. The non-parametric adaptation module can thus use this speech characteristics information to make adjustments to processing behavior defined by the configuration data provided to the speech synthesis system 130. Once the configuration data for the speech synthesis system 130 has been non-parametrically adapted, the speech synthesis system 130 processes an input sequence to generate intermediate output, for example, a mel spectrogram output, conditioned by the speaker encoder embedding vector. In some examples, the embedding vector that is provided with the output cloned synthesis model and/or that is used during the adaptation of the configuration data may be computed as a centroid vector of embedding vectors generated from utterances of the speech sample. The vocoder of the speech synthesis system 130 generates (i.e., in situations where one is included, for example, to allow adaptation of the vocoder to achieve improved performance of a downstream speech synthesis system) speech waveforms from the intermediate output.

The configuration data that is adapted based on the annotated speech sample 102 was previously generated according to an optimization process implemented by a learning-machine training controller for a multi-speaker model (schematically identified as multi-speaker model 124) using training audio data from multiple speakers (accessed from a data repository 122). For example, the system 100 may no longer have access to the original training audio yet may have the configuration data for the multi-speaker model, including the encoder that was used to form the embedding vectors for the speakers of the original training audio. The multi-speaker model may be implemented as a separate, remote, system from the speech synthesis system 130. The controller of the multi-speaker model 124 (that previously determined the configuration data based on the corpus of multi-speaker training data) is configured to determine and/or adapt the parameters (e.g., neural network weights) of a learning engine-based voice data synthesizer that would produce, for particular input text content, output representative of voice and speech characteristics consistent, or approximating, actual voice and speech characteristics for input data derived from a speech sample of the target speaker (in the embodiments of FIG. 1, that input data is a parametric representations). It is to be noted that during training time, the speech synthesis system used a training data set that may include speech samples (each associated with respective voice and speech characteristics) from multiple speakers (tens, hundreds, or thousands of speakers, with each sample including speech content of minutes to hundreds of hours). Such speech (audio) data may be associated with male and female speakers of different ages, and can include samples with different speech attributes (styles, prosody, etc.) and voice characteristics. In some embodiments, male and female speakers may be used to form separate different models (separate models may also be formed for different age groups for each gender-based grouping). Generally, the more voluminous the training data is, the higher the accuracy and confidence level associated with the output generated by the speech synthesis system.

After a learning-machine-based implementation of the speech synthesis system has become operational (following the training stage, and the transfer of the configuration data from the controller of the multi-speaker model 124 to the system 130) and can process actual runtime data, subsequent training may be intermittently performed (at regular or irregular periods) to dynamically adapt the speech synthesis system to new, and more recent training data samples in order to maintain or even improve the performance of the speech synthesis system. Such intermittent training would typically be supplemental to the non-parametric adaptation performed by the speech synthesis system. Thus, the intermittent training may be parametric adaptation (as opposed to the non-parametric adaptation performed for configuration data of the speech synthesis system 130 to adapt the system for the specific, unique speech characteristics of the target speaker) performed using the controller of the multi-speaker model 124.

When the speech synthesis system 130 is implemented as a neural network, the training (performed by the controller of the multi-speaker model 124) is used to define the parameter values (weights), represented as the vector θ assigned to links of the neural network, e.g., based on a procedure minimizing a loss metric between predictions made by the neural network and labeled instances of the data. An example of an optimization procedure to compute weights for a neural-network-based learning machine is a stochastic gradient descent procedure, which may be used to minimize the loss metric. The computed parameter values may be stored at a memory storage device (not shown) and intermittently transferred to the speech synthesis system 130 (e.g., upon receiving input for a new target speaker).

As noted, the speaker encoder 126 produces a parametric representation (e.g., embedding vector) to represent the target speaker's voice characteristics. In some implementation, the encoder 126 is trained to identify voice characteristics for the target speaker regardless of linguistic (e.g., phonetic, or semantic content, or language) and/or background noise. The encoder 126 may, for example, be implemented using a neural network model that is trained on a text-independent speaker verification task that seeks to optimize the generalized end-to-end (GE2E) loss so that embeddings of utterances from the same speaker have high cosine similarity, while those of utterances from different speakers are far apart in the embedding space. To generate a resultant vector from a time-domain speech sample (such as the sample 102), the encoder may be configured to transform the speech sample into a plurality of mel spectrogram frames, and map the plurality of mel spectrogram frame into a fixed-dimensional vector. Various implementations and configurations may be used to perform the mel spectrograms to embedding vector mapping. For example, in some embodiments, the resultant mel spectrograms are passed to a network that includes a stack of multiple Long Short-Term Memory (LSTM) layers, each followed by a projection to multiple dimensions. The resultant embedding vector may be produced by L2-normalizing of the output of the top layer at the final frame. During runtime, the encoder may be fed with portions of the speech sample broken into manageable windows (overlapping, or non-overlapping) that are processed independently by the encoder, with the outputs for each of the portions of the speech sample being averaged and normalized to produce the finalized embedding vector. In other example embodiments, the mapping of mel spectrograms to a parametric representation may be implemented using a convolutional neural network (CNN), followed by a stack of multiple (e.g., 3) Gated Recurrent Unit (GRU). Additional layers (such as projection layers) may also be included.

As further shown in FIG. 1, the speech synthesis and cloning system 130 includes a multi-speaker synthesizer 134, which generally includes the circuitry (neural learning-engine circuitry) that performs the processing on the parametric representation produced by the encoder 126 and the linguistic content input (that is to be converted into cloned/synthesized speech), and a non-parametric adaptation unit 132 that adjusts at least some of the adaptable portions of the multi-speaker synthesizer 134 (e.g., neural network weights) in accordance with the annotated speech sample 102. The non-parametric adaptation unit 132 adjusts the multi-speaker model into a speaker dependent model for the target speaker, that accounts for time-domain speech characteristics of the target speaker. The non-parametric adjustment typically is performed during cloning time (i.e., prior to run time), during which the clone model is produced (in accordance with the adaptation processes described herein), and loaded into a downstream synthesizer (not shown) that generates audio from text content in accordance with the adapted clone model. The multi-speaker synthesizer 134 implements a framework (which, in some embodiments, may be similar to the Tacotron™ architecture) that includes a token-to-spectrogram converter 140 to transform text-based linguistic content into mel spectrogram frames using a recurrent sequence-to-sequence feature prediction model. The token-to-spectrogram converter 140 may be trained on pairs of text-derived token sequences and audio derived mel spectrogram sequences. In some examples, the token-to-spectrogram converter may first map (using a learning-machine stage of the token-to-spectrogram converter 140) the input text-based linguistic content to a sequence of phonemes, which can lead to faster convergence and improved pronunciation of the synthesized speech. As noted, the speaker encoder 126 produces an embedding vector that conditions the performance of the multi-speaker synthesis system 134, thus allowing the speech synthesis system to implement transfer learning functionality. For example, the parametric representation (embedding vector) produced by the encoder 126 can be combined (concatenated) with an internal representation of intermediary values produced by the circuitry of the token-to-spectrogram converter 140 (e.g., through a concatenation module that adds the embedding vector to output of an intermediate stage of the token-to-spectrogram converter 140, through the use of an attention layer that receives, as input, the embedding vector, etc.) The output generated by the token-to-spectrogram converter 140 (e.g., mel spectrogram frames that are conditioned by the embedding vector) is provided to a voice encoder (vocoder) 142 that generates time-domain waveform samples from the mel spectrogram frames generated by the token-to-spectrogram converter 140 (an example of a vocoder that may be used with the system 100 of FIG. 1 is WaveNet™). It is to be noted that the vocoder 142 is optionally included with the multi-speaker synthesizer 134 for embodiments in which the multi-speaker synthesizer is configured to allow further adaptation to be performed individually on the vocoder or jointly on a combined implementation that includes the converter and the vocoder. In some embodiments, a vocoder may only be provided at a deployed runtime system (e.g., at a remote device or a central server that performs the synthesis of speech based on runtime linguistic content.

The non-parametric adaptation unit 132 adapts the configuration data for the speech synthesis system 130 by optimizing the parameters of the learning-machine implementation of the multi-speaker synthesizer 134 (and in particular the token-to-spectrogram converter 140) according to the annotated speech sample 102. Specifically, the non-parametric adaptation unit 132 uses the annotated speech sample 102 as a compact training set that includes actual target speech content (i.e., the audio content of the speech sample 102) and the corresponding text for that speech content aligned with the audio content. Thus, the audio content of the speech sample and the text-based content together define an aligned ground truth that can be used to further adjust the configuration data to minimize the error between the representation of the actual speech sample (e.g., a mel spectrogram representation derived from the speech sample) and the predicted mel spectrogram frames produced by the token-to-spectrogram converter 140 conditioned by the parametric representation produced from the speech sample. The adaptation of the configuration data may be performed directly on the configuration data as provided to the speech synthesis system 130, or may be performed at a separate learning-machine training controller (similar to the training controller engine that was used to compute the base configuration data from the multi-speaker training set 122), with the non-parametric adapted configuration data subsequently transferred to the multi-speaker synthesizer 134. The non-parametric adaptation, achieved through an optimization that uses the actual speech sample for the target user, can thus tweak the behavior of the multi-speaker synthesizer 134 to better match speech attributes (speech style, accent, prosody, etc.) of the target user, so that when arbitrary text-based content is provided to the speech synthesis system at runtime, the predicted output data representation (e.g., mel spectrograms, or time-domain waveforms) of the speech synthesis system 130 would more closely match the actual data representation that would be produced were the target speaker to recite the text-based content. In some embodiments, the optimization procedure to adjust the weights of the speech synthesis system based on the ground truth defined by the annotated speech sample (when the speech synthesis system is conditioned by an embedding vector for the speech sample) may be performed using a stochastic gradient descent procedure minimizing a predefined loss metric. Other optimization procedures may also be used to implement the non-parametric adaption.

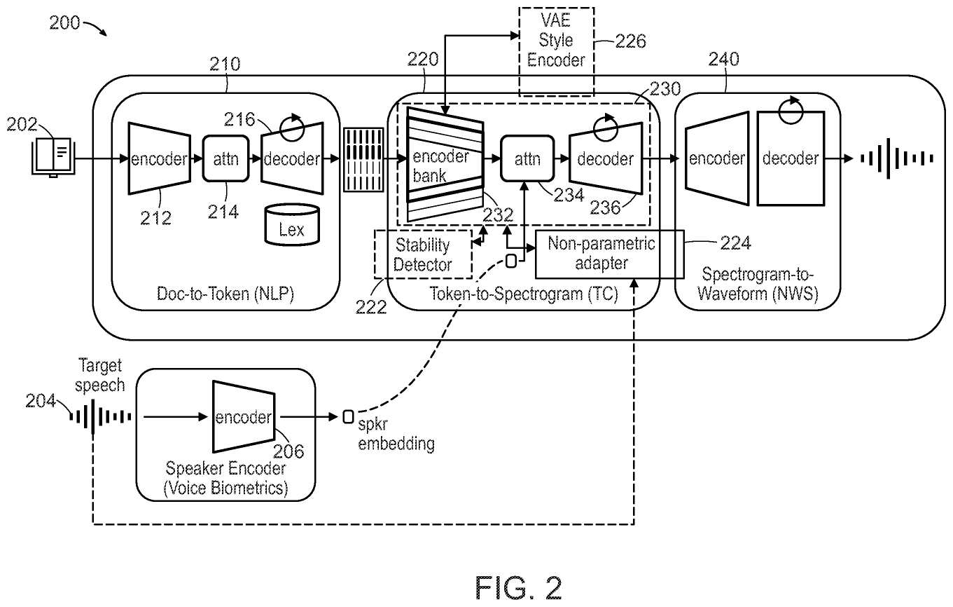

With continued reference to FIG. 1, as shown, the speech synthesis system 130 may optionally include a stability detector 136, in communication with the non-parametric adaptation unit 132 (or alternatively, in communication with the multi-speaker synthesizer 134 in embodiments in which further training and adaptation is performed directly on configuration data maintained by the multi-speaker synthesizer 134). As will be discussed in greater detail below (in reference to FIG. 2), the stability detector is configured to determine whether the non-parametric adaption performed using the short (e.g., 2-3 min, 10 min) annotated speech sample for the target speaker (e.g., during cloning time operations) is converging to a stable solution. To that end, the stability detector computes an adaptation stability metric representative of adaptation performance for adapting the configuration data, and aborts the adapting of the configuration data in response to a determination that the computed adaptation stability metric indicates unstable conditions for the adaptation of the configuration data. In some examples, if instability is detected, and the non-parametric adaptation is aborted, the non-parametric adaptation unit 132 is configured to cause the obtaining (e.g., by the audio collection unit 112) of a new speech sample for the target speaker, and subsequently performs the adapting of the configuration data using the new speech sample (the new acquired speech sample would generally also need to be processed by the audio validation unit 114 and the automatic transcription unit 116). Alternatively, instead of acquiring a new speech sample (which may not be possible if the target speaker is not available to produce another sample), the non-parametric adaptation unit 132 may simply restart the adaptation process by re-initializing the configuration data (i.e., discarding the configuration data that has already been partly modified), and re-acquiring the base configuration data (from the multi-speaker synthesizer 134 or from the multi-speaker model 124). An unstable adaptation is often caused due to bad initialization of the adaptation process, and thus, under such circumstances, the unstable condition can be remedied by restarting the adaptation process with the same annotate speech sample from the target speaker. Initialization generally depends on a random seed. By restarting, the seed would change and the outcome may be different, with a goal of avoiding instability that may occur with other random seeds.

In some embodiments, the adaptation stability metric computed may be attention data for portions of the speech sample (which may be representative of entropy), and aborting the adapting of the learning-machine-based synthesizer may include aborting the adapting of the learning-machine-based synthesizer in response to a determination that attention dispersion level derived from the attention data indicates a non-converging adapting solution for the speech synthesis system.

FIG. 2 is a schematic diagram of an example embodiment of a speech synthesizing section 200 that may be configured and implemented, at least in part, similarly to the speech synthesizing section 120. The schematic diagram of FIG. 2 provides some additional details to what was depicted and discussed in relation to FIG. 1.

The speech synthesizing section 200 includes a doc-to-token stage 210 to process and adapt input linguistic content for compatibility with a token-to-spectrogram (TC) stage 220 (some of the functionality and/or implementation of the token-to-spectrogram stage 220 may be similar to the functionality and/or implementation of the token-to-spectrogram converter 140 of the multi-speaker synthesizer 134 of FIG. 1). The doc-to-token stage 210, which may be implemented as a learning machine with an encoder-attention-decoder configuration (identified, respectively, as units 212, 214, and 216) is trained to perform natural language processing on text-based linguistic content such as the content provided in document 202, and to produce output (typically segmented into multiple portions that are gradually provided as input to the token-to-spectrogram section 220). It is to be noted that other configurations for the doc-to-token stage 210 (or any other stages), and not only encoder-attention-decoder configuration, may alternatively be used. The NLP processing divides the document into linguistically meaningful and processable portions (e.g., into syllables, or into groupings of one or more phonemes) according to semantic and syntactical content recognized by the machine learning implementation of the doc-to-token stage 210. The actual output provided to the token-to-spectrogram stage 220 may depend on the implementation the token-to-spectrogram stage 220, particularly the type of input that the stage 220 accepts. The tokens can be actual sequences of text-based characters (corresponding to, for example, syllables and phonemes detected and parsed by the doc-to-token stage 210), or may be some other type of encoded output data, e.g., encoded parametric data representative of the linguistic content parse by the doc-to-token stage 210.

The token-to-spectrogram stage 220 is configured to produce a linguistic representation of the tokenized text-based content, with that linguistic representation (e.g., in the form of outputted spectrogram, or mel spectrograms) being representative of voice characteristics approximating the voice characteristics (e.g., timbre) of the target speaker. The token-to-spectrogram stage 220 includes a speech synthesizer 230, which may be similar in functionality and implementation to the converter 140 (of the multi-speaker synthesizer 134) of FIG. 1, may be implemented as a learning machine with an encoder-attention-decoder configuration (identified, respectively, as units 232, 234, and 236). As discussed in relation to FIG. 1, a speaker encoder 206 (similar to the encoder 126 of FIG. 1) receives a speech sample 204 (which may be annotated) for the target speaker, and converts the speech sample into a parametric representation (e.g., an embedding vector) that is provided to the token-to-spectrogram stage 220 to condition the output produced by the speech synthesizer 230. In some embodiments, computation of the embedding vector may be performed during the voice clone training time. During inference time, the pre-computed speaker embedding vector is used for that specific speaker.

The parametric representation represents voice characteristics of the speaker (and thus, different voice characteristics will result in different parametric representation). In the embodiments of FIG. 2, the parametric representation is combined with the data processed by the speech synthesizer 230 through the attention unit 234 (the attention unit is configured to identify and track (and amplify) important portions of the encoder unit 232's output).

To more closely approximate predicted spectrograms produced by the token-to-spectrogram stage 220 to spectrograms that would be produced directly from audio samples of the target speaker, a non-parametric adapter 224 (which may be similar in functionality and implementation to the non-parametric adaptation unit 132 of FIG. 1), receives the speech sample 204, and a corresponding text-based content aligned with the audio content of the speech sample (this adaptation is typically performed during cloning adaptation time, prior to runtime deployment). The non-parametric adapter 224 uses the speech sample and accompanying text-based annotation to further train the speech synthesizer 230 (and thus adapt the base configuration data of the speech synthesizer 230) for specific target speaker. During the adaptation also the utterance-level speaker embeddings are used as input. As noted, this process generally happens during cloning adaptation time, prior to runtime deployment. As also noted, the adaptation may be performed by using the text-based annotation to predict resultant spectrograms (using the base configuration data, conditioned by the parametric representation), and adapting/adjusting weights (or other parameters) of the learning machine implementation of the speech synthesizer 230 to decrease an error (using some pre-specified loss or error function) between the predicted spectrograms and spectrograms produced directly from the target speech sample 204.

In some embodiments, speech characteristics, such as prosodic style, may be approximated by the output of the system 200 by modelling the speech characteristics through Variational Autoencoders. In such embodiments, during the training stage style embeddings are computed (at utterance level) from input MEL spectrograms for the training speakers. At inference time (runtime), a fuzzy matching scheme may be used to find the most relevant style embedding (with respect to the sequence to be generated) from those available in the target speaker data. Thus, as depicted in FIG. 2, the token-to-spectrogram stage 220 optionally includes a variational autoencoder (VAE) style encoder 226 that is configured to encode a reference audio (e.g., mel spectrogram frames for a speaker) into a parametric style representation (e.g., a fixed-dimensioned vector) of the prosodic style of the speaker. The resultant parametric style representation is provided, in the example of FIG. 2, to the encoder unit 232 of the token-to-spectrogram stage 220, which combines the parametric style representation with the encoder states (either as input to the encoder, or as additional data added to intermediate processed encoder data). The parametric style representation may be added to the output of the encoder 232. In some embodiments, the parametric style representation may be combined with other modules of the token-to-spectrogram stage 220, or may be combined at an earlier or later stage of the processing performed by the speech synthesis section 200. The parametric style representation (which is part of the multi-speaker model) may be included during the non-parametric adaptation (performed by the adapter 224) or at other times.

The use of an attention unit 234 in the example configuration of the speech synthesizer 230 implementation also provides a convenient way to track the performance of the non-parametric adaptation training and to determine the stability of an optimization solution during, for example, the non-parametric adaptation that uses the speech sample 204. Generally, for a converging optimization solution in a sequence-to-sequence model, the attention matrix (for the attention unit 234) should display monotonous behavior with few or no skips (which might result from imprecise phonetic transcription and/or presence of empty syntactic or boundary symbols). Typically, during an initial training stage the attention matrix has a wide spread of values, and gradually moves toward a unimodal probabilistic distribution across the attention weights at future decoding steps. In such systems, the attention weight entropy, averaged over the utterances of a validation set, may indicate attention convergence when the system is evaluated in inference mode. Thus, when an optimization solution is converging, the time-dependent (or step-dependent) behavior for various stability metrics (e.g., entropy, robustness, etc.) should have predictable characteristics.

An example of a stability metric that may be computed (e.g., by a stability detector 222) during the non-parametric adaptation is that of attention weight entropy. Entropy is used to represent attention dispersion. Entropy increases when attention is more scattered. One way to compute an entropy metric for the attention behavior of the system is as follows. Given a training set with K-point input phonetic sequence and a respective N-point output acoustic sequence, the average utterance entropy can be computed as:

$${E}_{avg}^{u t t} = \frac{1}{N} {\sum }_{n = 1}^{N} {\sum }_{k = 1}^{K} - {a}_{k , n} log {a}_{k , n}$$

where a_{k,n} is the (k, n) entry of the K×N alignment matrix assigning an attention weight linking the n^{th} observation with the k^{th} input symbol. During convergence of a solution (e.g., based on error between the predicted acoustic frames and acoustic frames directly derived from the speech sample for the target speaker), the computed entropy should yield (as a function of training step) a substantial uniform behavior of low entropy. If there are jumps in the computed entropy, this may be indicative of loss of convergence (i.e., an unstable solution). As noted, other metrics indicative of an unstable (non-converging) solution may be formulated.

Generally, because attention behavior is dependent on initial conditions, an unstable solution can be remedied by re-starting the non-parametric adaptation. Alternatively, the stability detector may be configured to cause a speech acquisition system (such as the audio collection unit 112 of the speech acquisition section 110 of FIG. 1) to prompt the target speaker to record a new speech sample, that is then processed (validated and transcribed) in a manner similar to that discussed with relation to FIG. 1.

With continued reference to 2, the system 200 also includes a spectrogram-to-waveform stage 240 which is configured to transform the resultant output of the speech-synthesizer 230 into audio waveforms. The stage spectrogram-to-waveform 240 may be implemented similarly to the voice encoder (vocoder) 142 of FIG. 1. For example, the spectrogram-to-waveform stage may be implemented using a WaveNet™ vocoder The spectrogram-to-waveform stage 240 be implemented on the same device as the rest of the system 200, or may be implemented on a remote device separate from the device where other stages reside.

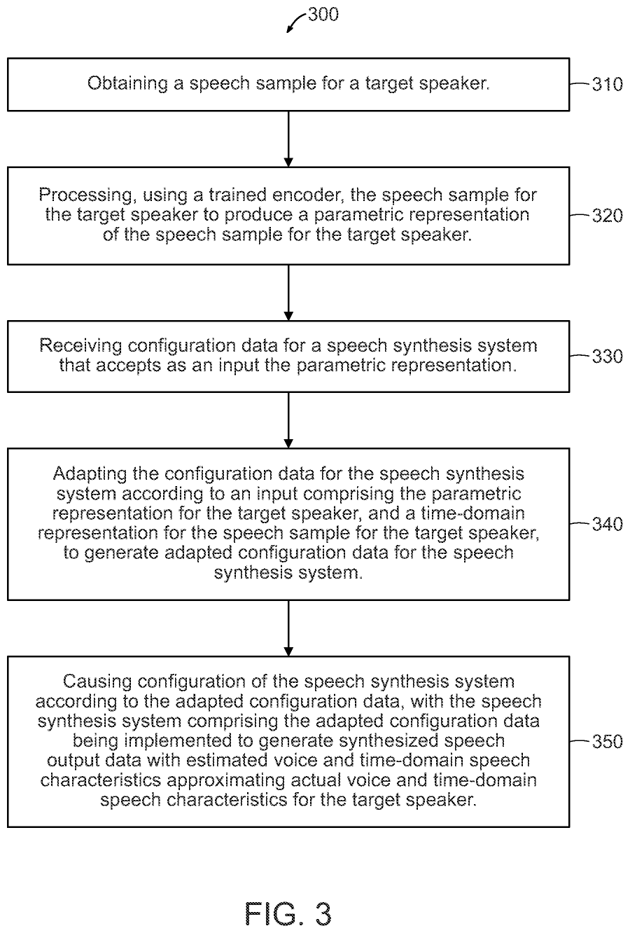

With reference now to FIG. 3, a flowchart of an example procedure 300 for speech generation is shown. The procedure 300 includes obtaining 310 a speech sample for a target speaker. In some examples, obtaining the speech sample for the target speaker may include obtaining a speech corresponding to a linguistic representation of spoken content of the speech sample. In such examples, obtaining the speech sample for the target speaker may include conducting a scripted data collection session with the target speaker, including prompting the target speaker to utter the spoken content. The procedure may further include performing audio validation analysis for the speech sample to determine whether the speech sample satisfies one or more audio quality criteria, and obtaining a new speech sample in response to a determination that the speech sample fails to satisfy the one or more audio quality criteria. In some situations, the procedure may additionally include applying filtering and speech enhancement operations (e.g., equalization, denoising, dereverberation, etc.) on the speech sample to enhance quality of the speech sample.

The procedure 300 additionally includes processing 320, using a trained encoder (such as the encoders 126 and 206 of FIGS. 1 and 2, respectively), the speech sample for the target speaker to produce a parametric representation (e.g., embedding vector) of the speech sample for the target speaker. For example, processing the speech sample for the target speaker to produce the parametric representation may include transforming the speech sample for the target speaker into a spectral-domain vector representation (e.g., representative of voice characteristics for the target speaker). In some embodiments, transforming the speech sample into the spectral-domain vector representation may include transforming the speech sample into a plurality of mel spectrogram frames, and mapping the plurality of mel spectrogram frame into a fixed-dimensional vector.

With continued reference to FIG. 3, the procedure 300 also includes receiving 330 configuration data for a speech synthesis system that accepts as an input the parametric representation. The configuration data may include weights for neural-network-based implementation of the speech synthesis system. In some examples, the received configuration data for the speech synthesis system is derived from training speech samples from multiple training speakers distinct from the target speaker.

The procedure 300 further includes adapting 340 the configuration data for the speech synthesis system according to an input comprising the parametric representation for the target speaker, and a time-domain representation for the speech sample for the target speaker, to generate adapted configuration data for the speech synthesis system representing the target speaker. As noted, in some examples, during the adaptation the parametric representation of speaker may not be a single vector, but rather may be provided at utterance-level. In some embodiments, adapting the configuration data according to the time-domain representation may include matching the speech sample and corresponding linguistic annotation for the speech sample to generate an annotated speech sample identifying phonetic and silent portions, and respective time information, with the annotated speech sample representing the time-domain speech attributes data for the target speaker, and adapting the configuration data for the speech synthesis system according to, at least in part, the annotated speech sample representing the time-domain speech attributes data for the target speaker. The time-domain speech attributes data for the target speaker may include one or more of, for example, speech pronunciation by the target speaker, accent of the target speaker, speech style for the target speaker, and/or prosody characteristics for the target speaker. It is to be noted that when adapting the configuration data, the various speech attributes may not be explicitly expressed in the configuration data (e.g., a single parameter representing a specific accent) but typically would be latently expressed (i.e., these speech attributes would be encoded into the configuration data as a result of the adaptation process, and may not be able to be disentangled). The linguistic annotation may include word and/or sub-word transcriptions, and matching the speech sample the corresponding linguistic annotation may include aligning word and/or subword elements of the transcriptions with the time-domain representation of the target speech sample for the target speaker.

An example of adapting the configuration data for the speech synthesis system according to the parametric representation for the target speaker and the time-domain representation for the speech sample may include adapting the configuration data using a non-parametric adaptation procedure to minimize error between predicted spectral representation data produced by the speech synthesis system in response to the parametric representation and text-data matching the speech sample for the target speaker, and actual spectral data directly derived from the speech sample.

In some embodiments, adapting the configuration data may include computing an adaptation stability metric representative of adaptation performance for adapting the configuration data, and aborting the adapting of the configuration data in response to a determination that the computed adaptation stability metric indicates unstable adaptation of the configuration data. In such embodiments, the procedure may further include re-starting the adapting of the configuration data using the speech sample for the target speaker. In some examples, the procedure may further include obtaining, following the aborting, a new speech sample for the target speaker, and performing the adapting of the configuration data using the new speech sample. Computing the adaptation stability metric may include computing attention data for portions of the speech sample. In such embodiments, aborting the adapting of the learning-machine-based synthesizer may include aborting the adapting of the learning-machine-based synthesizer in response to a determination that attention dispersion level derived from the attention data indicates a non-converging adapting solution for the speech synthesis system.

In some embodiments, the procedure may also include generating, using a variational autoencoder, a parametric style representation for the prosodic style associated with the speech sample. In such embodiments, adapting the configuration data may include adapting the configuration data for the speech synthesis system based further on the parametric style representation.

Turning back to FIG. 3, the procedure additionally includes causing configuration of the speech synthesis system according to the adapted configuration data, with the speech synthesis system comprising the adapted configuration data being implemented to generate synthesized speech output data with estimated voice and time-domain speech characteristics approximating actual voice and time-domain speech characteristics for the target speaker.

The procedure 300 may additionally include generating the synthesized speech output data, including processing a target linguistic input by applying the speech synthesis system configured with the adapted configuration data to the target linguistic input to synthesize speech with the voice and time-domain speech characteristics approximating the actual voice and time-domain speech characteristics for the target speaker uttering the target linguistic input. It is to be noted that the generating of the synthesized speech output data also includes cross-lingual situations, where synthetic speech is generated in a language that is different from the language used in the collected speech sample.

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The system may also be considered to be implemented as a tangible, non-transitory medium, configured with a computer program, where the medium so configured causes a computer to operate in a specific and predefined manner to perform one or more of the processing steps described herein.

Implementation using neural networks can be realized on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's), and may also include special purpose logic circuitry, e.g., an FPGA (field programmable gate array), an ASIC (application-specific integrated circuit), a DSP processor, an accelerated processing unit (APU), an application processor, customized dedicated circuitry, etc., to implement, at least in part, the processes and functionality for the neural networks (or other types of learning machines), procedures, and methods described herein. The computing platforms used to implement the neural networks typically also include memory for storing data and software instructions for executing programmed functionality within the device. The various learning processes implemented through use of the neural networks may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, etc.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of +20% or +10%, +5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of +20% or +10%, +5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method for speech generation comprising:
obtaining a speech sample for a target speaker;
processing, using a trained encoder, the speech sample for the target speaker to produce a parametric representation of the speech sample for the target speaker;
receiving configuration data for a speech synthesis system that accepts as an input the parametric representation;
adapting the configuration data for the speech synthesis system according to an input comprising the parametric representation for the target speaker, and a time-domain representation for the speech sample for the target speaker, to generate adapted configuration data for the speech synthesis system representing the target speaker; and
causing configuration of the speech synthesis system according to the adapted configuration data, wherein the speech synthesis system comprising the adapted configuration data is implemented to generate synthesized speech output data with estimated voice and time-domain speech characteristics approximating actual voice and time-domain speech characteristics for the target speaker.

2. The method of claim 1, wherein the configuration data comprises weights for neural-network-based implementation of the speech synthesis system.

3. The method of claim 1, wherein adapting the configuration data according to the time-domain representation comprises:
matching the speech sample and corresponding linguistic annotation for the speech sample to generate an annotated speech sample identifying phonetic and silent portions, and respective time information, wherein the annotated speech sample represents the time-domain speech attributes data for the target speaker; and
adapting the configuration data for the speech synthesis system according to, at least in part, the annotated speech sample representing the time-domain speech attributes data for the target speaker.

4. The method of claim 3, wherein the time-domain speech attributes data for the target speaker comprise one or more of: speech pronunciation by the target speaker, accent of the target speaker, speech style for the target speaker, or prosody characteristics for the target speaker.

5. The method of claim 3, wherein the linguistic annotation includes word and/or sub-word transcriptions, and wherein matching the speech sample the corresponding linguistic annotation comprises:
aligning word and/or subword elements of the transcriptions with the time-domain representation of the target speech sample for the target speaker.

6. The method of claim 1 through 5, further comprising generating the synthesized speech output data, including processing a target linguistic input by applying the speech synthesis system configured with the adapted configuration data to the target linguistic input to synthesize speech with the voice and time-domain speech characteristics approximating the actual voice and time-domain speech characteristics for the target speaker uttering the target linguistic input.

7. The method of claim 1, wherein obtaining the speech sample for the target speaker comprises obtaining a speech corresponding to a linguistic representation of spoken content of the speech sample.

8. The method of claim 7, wherein obtaining the speech sample for the target speaker comprises conducting a scripted data collection session with the target speaker, including prompting the target speaker to utter the spoken content.

9. The method of claim 8, further comprising:
performing audio validation analysis for the speech sample to determine whether the speech sample satisfies one or more audio quality criteria; and
obtaining a new speech sample in response to a determination that the speech sample fails to satisfy the one or more audio quality criteria.

10. The method of claim 7, further comprising:
applying filtering and speech enhancement operations on the speech sample to enhance quality of the speech sample.

11. The method of claim 1, wherein the received configuration data for the speech synthesis system is derived from training speech samples from multiple training speakers distinct from the target speaker.

12. The method of claim 1, wherein adapting the configuration data comprises:
computing an adaptation stability metric representative of adaptation performance for adapting the configuration data; and
aborting the adapting of the configuration data in response to a determination that the computed adaptation stability metric indicates unstable adaptation of the configuration data.

13: The method of claim 12, further comprising:
re-starting the adapting of the configuration data using the speech sample for the target speaker.

14. The method of claim 12, further comprising:
obtaining, following the aborting, a new speech sample for the target speaker; and
performing the adapting of the configuration data using the new speech sample.

15. The method of claim 12, wherein computing the adaptation stability metric comprises computing attention data for portions of the speech sample;
and wherein aborting the adapting of the learning-machine-based synthesizer comprises aborting the adapting of the learning-machine-based synthesizer in response to a determination that attention dispersion level derived from the attention data indicates a non-converging adapting solution for the speech synthesis system.

16. The method of claim 1, wherein processing, using the trained encoder, the speech sample for the target speaker to produce the parametric representation comprises:
transforming the speech sample for the target speaker into a spectral-domain vector representation.

17. The method of claim 16, wherein transforming the speech sample into the spectral-domain vector representation comprises:
transforming the speech sample into a plurality of mel spectrogram frames; and
mapping the plurality of mel spectrogram frame into a fixed-dimensional vector.

18. The method of claim 1, further comprising:
generating, using a variational autoencoder, a parametric style representation for the prosodic style associated with the speech sample;
wherein adapting the configuration data comprises adapting the configuration data for the speech synthesis system based further on the parametric style representation.

19. The method of claim 1, wherein adapting the configuration data for the speech synthesis system according to the parametric representation for the target speaker and the time-domain representation for the speech sample comprises:
adapting the configuration data using a non-parametric adaptation procedure to minimize error between predicted spectral representation data produced by the speech synthesis system in response to the parametric representation and text-data matching the speech sample for the target speaker, and actual spectral data directly derived from the speech sample.

20. A speech generation system comprising:
a speech acquisition section to obtain a speech sample for a target speaker;
an encoder, applied to the speech sample for the target speaker, to produce a parametric representation of the speech sample for the target speaker; and
a speech synthesis and cloning system comprising:
a receiver to receive configuration data for the speech synthesis system, wherein the speech synthesis system is configured to accept as an input the parametric representation; and
an adaptation module to adapt the configuration data for the speech synthesis system according to an input comprising the parametric representation for the target speaker, and a time-domain representation for the speech sample for the target speaker, to generate adapted configuration data for the speech synthesis system representing the target speaker;
wherein the adaptation module causes configuration of the speech synthesis system according to the adapted configuration data, and wherein the speech synthesis system comprising the adapted configuration data is implemented to generate synthesized speech output data with estimated voice and time-domain speech characteristics approximating actual voice and time-domain speech characteristics for the target speaker.

21. The system of claim 20, wherein the speech acquisition section comprises one or more of: i) an audio collection unit to collect and record the speech sample, ii) a speech validation unit configured to perform audio validation analysis for the speech sample to determine whether the speech sample satisfies one or more audio quality criteria, and/or to apply filtering operations on the speech sample to enhance quality of the speech sample, or iii) an automatic audio transcription unit configured to generate an annotated speech sample from the collected speech sample.

22. A non-transitory computer readable media storing a set of instructions, executable on at least one programmable device, to:
obtain a speech sample for a target speaker;
process, using a trained encoder, the speech sample for the target speaker to produce a parametric representation of the speech sample for the target speaker;
receive configuration data for a speech synthesis system that accepts as an input the parametric representation;
adapt the configuration data for the speech synthesis system according to an input comprising the parametric representation for the target speaker, and a time-domain representation for the speech sample for the target speaker, to generate adapted configuration data for the speech synthesis system representing the target speaker; and
cause configuration of the speech synthesis system according to the adapted configuration data, wherein the speech synthesis system comprising the adapted configuration data is implemented to generate synthesized speech output data with estimated voice and time-domain speech characteristics approximating actual voice and time-domain speech characteristics for the target speaker.

23. A computing apparatus comprising:
a speech acquisition section to obtain a speech sample for a target speaker; and
one or more programmable processor-based devices to generate synthesized speech according to the steps of claim 1.

24. A non-transitory computer readable media programmed with a set of computer instructions executable on a processor that, when executed, cause the operations comprising the method steps of claim 1.
